(19) United States
(12) Patent Application Publication
(10) Pub. No.: US 2024/0223691 A1
(43) Pub. Date: Jul. 4, 2024

(54) System, Method and Apparatus for Communication with Occupants of a Vehicle

(71) Applicant: Eddie B. Lofton, Grayson, GA (US)

(72) Inventor: Eddie B. Lofton, Grayson, GA (US)

(21) Appl. No.: 18/149,171

(22) Filed: Jan. 3, 2023

(51) Int. Cl. H04M 1/72418; H04W 4/029; H04W 4/90

(52) U.S. Cl. CPC H04M 1/72418; H04W 4/029; H04W 4/90

(57) ABSTRACT

A system for communicating between a responder and a caller that is requesting help includes a call center for receiving the call for help from a cellphone of the caller and a way for the call center to dispatch a responder. A call center computer digitally communicates with a safetalk application that is running on the cellphone. The call center also digitally communicates with a responder device. The call center computer establishes a voice-over-IP call between the cellphone and the responder device providing voice communications between the caller and the responder. In some embodiments, a location of the responder is periodically sent to the cellphone and the safetalk application updates the caller as to progress of the responder reaching the caller.

### FIELD OF THE INVENTION

This invention relates to the field of communications and more particularly to a system for communicating with an occupant of a vehicle.

### BACKGROUND OF THE INVENTION

There are many needs for communicating with an occupant of a vehicle, car, bus, truck, etc. Examples of such are to initiate a transaction at a drive through window, answering questions at a roadblock or checkpoint, during a traffic stop, etc. Currently, to perform such communications requires that an occupant of the vehicle open a window or door and communicate through that open window or door.

Often, a stranded motorist or a witness to an accident will call an emergency number (e.g., e911) to request help. The call is usually answered by a call center and after obtaining information from the caller, help is dispatched, for example, an officer or a road warrior is dispatched to the location of the stranded motorist or accident. In the past, once the call for help is disconnected, the motorist (or witness) does not have further contact with the dispatched help until the officer or road warrior (responder) arrives at the scene. Often there is a need to provide voice contact between the caller and the officer or road warrior while they travel to the scene, for example, so the responder is able to gather further information regarding the issue of to comfort the caller. Further, for safety reasons, it is desired that the responder be in voice communications with the caller upon arrival at the scene to survey the level of safety for the responder before exiting of the responder's vehicle. Further, in certain climates, weather makes it uncomfortable and inconvenient for the caller to open their window or for the responder to leave the responder's vehicle.

There are existing ways to perform communications between the caller and the responder, none of which are practical. For example, a cellular phone can be used to establish a voice call with the occupant. This is not practical because there is no established protocol for conveying the caller's phone number to a responder or visa versa and such may be a violation of privacy to either the caller or to the responder. From a privacy point of view, many first responders do not wish others to know their cellular phone number which may be a cause for unwanted phone calls.

What is needed is a system that will enable two-way voice communication between the caller and the responder without requiring disclosure of either the caller's cellphone number or the responder's cellphone number.

### SUMMARY OF THE INVENTION

In one embodiment, a system for communicating with an occupant of a vehicle, for example, between a caller that is requesting help and a responder includes a call center for receiving the call for help from a cellphone of the caller and a way for the call center to dispatch a responder. A call center computer connects to a safetalk application that runs on the cellphone. The call center computer also connects to a responder device. The call center initiates a voice connection between the cellphone of the caller and the responder device, e.g., using voice-over-IP, for providing voice communications between the caller and the responder. In some embodiments, a location of the responder device is periodically read and conveyed to the safetalk application running on the cellphone for updating an estimated time of arrival of the responder or displaying an actual location of the responder on a cellphone display.

In another embodiment, a system for communicating between a responder and a caller requesting help includes a call center having a way to receive a call from a caller device of the caller, the call center has a call center computer. The call center has a way to dispatch a responder who has a responder device. The responder device has a display, processor, memory, audio input and audio output. There is a way to install and run a safetalk application on the caller device. Note that the caller device has a caller device processor and a caller device display. The call center computer is configured to connect to the safetalk application that is running on the caller device and to connect to an application running on the responder device. After the call is received, the call center computer establishes a voice-over-IP call between the safetalk application running on the caller device and the application running on the responder device, thereby voice communications are initiated between the caller and the responder.

In another embodiment, a method for communicating between a responder and a caller requesting help includes receiving a call coming from a caller device of the caller at a call center, the call center having a call center computer, and dispatching a responder (e.g., an officer, a tow truck, a road ranger) by the call center. The responder has a responder device that has a display, processor, memory, audio input and audio output. A safetalk application is run on the caller device; the caller device has a caller device processor and a caller device display. The call center computer connects to the safetalk application that is running on the caller device and connects to an application running on the responder device. The call center computer initiates a voice-over-data connection between the safetalk application running on the caller device and the application running on the responder device, thereby providing voice communications between the caller and the responder.

In another embodiment, a system for communicating between a responder and a caller requesting help includes a call center having a way to receive a call from a caller device of the caller. The call center has a call center computer. The responder has a responder device with a display, processor, memory, audio input and audio output. A safetalk application is installed on the caller device. The caller device has a caller device processor and a caller device display. The call center computer connects to the safetalk application that is running on the caller device processor of the caller device and connects to an application running on the processor of the responder device. The call center computer establishes a voice-over-data call (e.g., Voice over IP or VOIP) between the safetalk application running on the caller device processor and the application running on the processor of the responder device, thereby, voice communications are initiated between the caller and the responder.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a plan view illustrating a system for communicating between a responder and a caller (e.g., a person requesting assistance).

FIG. 2 illustrates communication equipment in vehicles of the system for communicating between a responder and a caller.

FIG. 3 illustrates communications between the responder and caller in the system for communicating between a responder and a caller.

FIG. 4 illustrates an exemplary device used by a caller to initiate a call for help or for a responder to communicate during a response.

FIG. 5 illustrates an exemplary computer system used by a call center to process a call for help and dispatch a responder.

FIGS. 6-8 illustrates exemplary user interfaces of the system for communicating between a responder and a caller.

FIGS. 9 and 10 illustrate sample program flows of the system for communicating between a responder and a caller.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

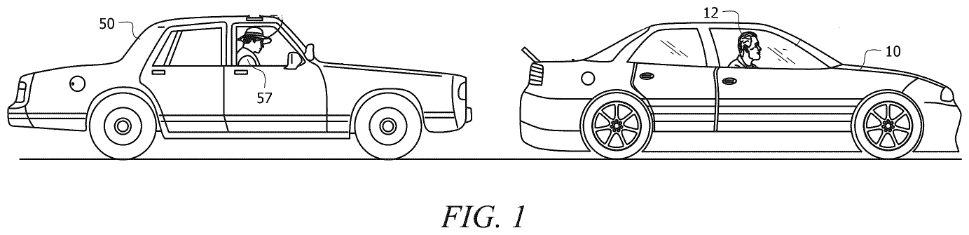

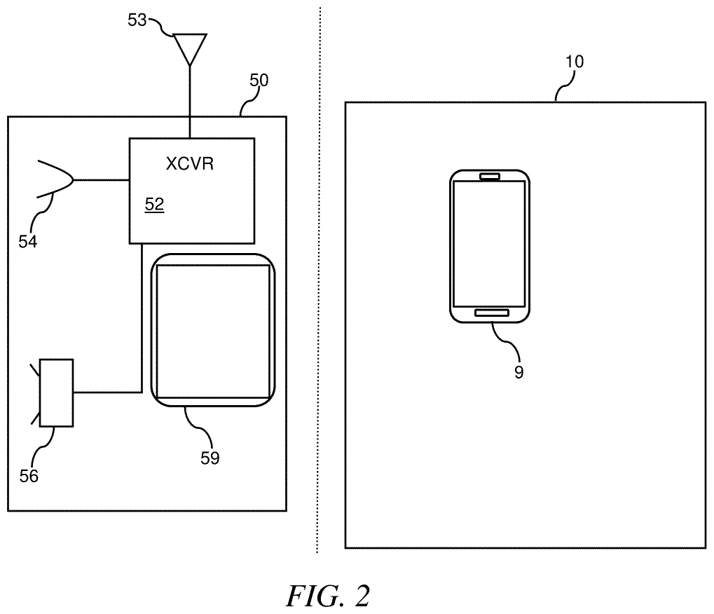

Referring to FIG. 1, a perspective view of a system for communicating between a responder 57 and a caller 12 will be described. The system for communicating between a responder 57 and a caller 12 is anticipated to be used when a caller 12 in a caller vehicle 10 requests assistance and a responder 57 in a responder vehicle 50 (e.g., police or road ranger) is dispatched for assistance, for example, by a dispatcher at a call center 81 (see FIG. 2). In the example shown in FIG. 1, the response vehicle 50 is shown as a law-enforcement vehicle as an example of a responder vehicle 50, though other types of responder vehicles 50 are equally anticipated such as tow trucks, road warriors, etc.

Prior to the present invention, during travel to the location of the caller 12, the responder 57 had limited or no communication with the caller 12. Having no communications with the caller 12, the responder 57 is unable to assess the situation and is unable to comfort the caller 12 with arrival information and status.

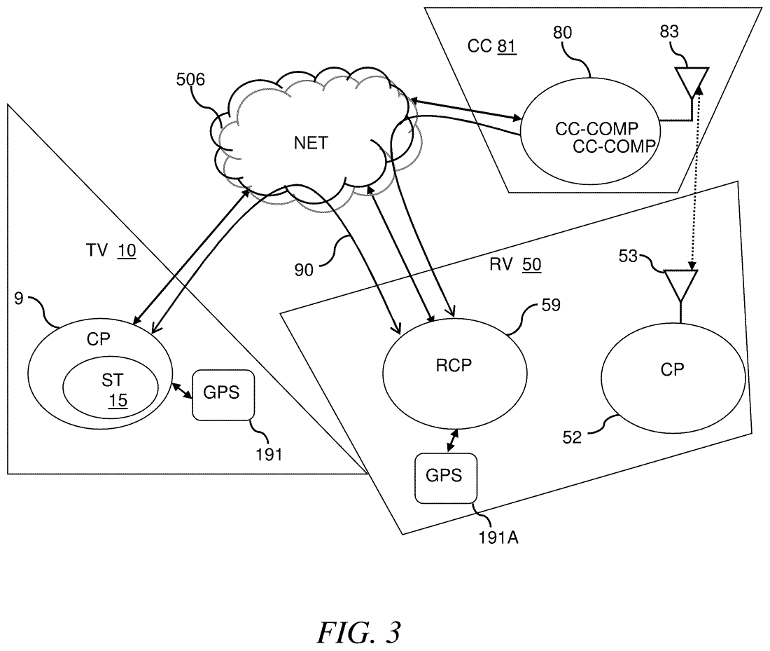

Referring to FIG. 2, communication equipment in vehicles of the system for communicating between a responder 57 and a caller 12 is shown. In general, the caller 12 has a caller device 9 (e.g., a cellphone or smartphone) that is capable of making calls (e.g., the emergency call) and installing and running a safetalk application 15 (see FIG. 3). Today, most caller devices 9 have data capabilities (e.g., a smartphone) and are able to make voice connections using a data transport, for example, using voice over internet protocol connections (VOIP). In most situations, the responder 57 has a responder device 59 (for example, a tablet computer or a smartphone) and often a vehicular radio that has a transceiver 52 with antenna 53, a microphone 54 and audio transducer 56. Often, the responder 57 communicates with the call center 81 using the vehicular radio over dedicated communications wavelengths. In most embodiments, the responder device 59 has a display, processor, audio sensor (e.g., a microphone), and an audio transducer (e.g., speaker or headphone).

Prior to the system for communicating between a responder 57 and a caller 12, the responder device 59 was not used to communicate with the caller device 9 due to privacy concerns and, for some configurations, the responder device 59 did not have the ability to make phone calls, for example, to make a phone call to the caller device 9 over the cellular network. For example, if the responder device 59 is a tablet computer that is connected to the call center computer 80 through a data network, in the past, the responder device 59 receives/sends data to the call center computer 80 over that network, but even though many tablet computers have a speaker and microphone, they were not used to convey audio messages or make phone calls to the caller device 9 as such would divulge addressing information such as an IP address and/or a phone number associated with the responder device 59.

Referring to FIG. 3, communications between the responder 57 in a responder vehicle 50 and caller 12 in a caller vehicle 10 are shown communicating by way of the system for communicating with an occupant of a vehicle.

As in the past, the call center 81 (e.g., road assistance call center, call center for 911 calls) communicates either directly or indirectly with the responder vehicle 50 (and responder 57) by a two-way radio between antenna 83/53 or any other way known in the art. Note that the communications between the call center computer 80 and the responder vehicle 50 are typically trusted, typically encrypted, whereas communications with the caller vehicle 10 are not generally trusted and, therefore, it is desired to not convey any connection data of the responder vehicle 50 (responder device 59) with the caller vehicle 10 such as a phone number or address of any device associated with the responder vehicle 50 or the responder for privacy and security reasons.

In the past, the caller 12 made a call for assistance using the caller device 9 in possession of the caller 12 (e.g., through the data network 506 including the cellular network). The call for assistance is answered, for example, by a dispatcher in the call center 81 and the call center 81 dispatches the responder 57, for example, through the two-way radio between antenna 83/53. In the past, there was no voice communications established directly between the responder 57 and the caller 12.

In the present disclosed system, the safetalk application 15 is either previously installed on the caller device 9 or installed under direction of the dispatcher by, for example, verbal instructions from the dispatcher or the dispatcher sending a download link to the caller device 9. The call center computer 80 connects with the safetalk application 15 running on the caller device 9 of the caller 12 (e.g., through the data network 506 which, in some embodiments, includes the Internet and/or cellular network). The safetalk application 15 has voice over data capabilities, for example, voice-over-IP connection capabilities. After the safetalk application 15 is ready, the call center computer 80 connects an application running on the responder device 59 (e.g., through the data network 506 or a private data network) to the safetalk application 15 running on the caller device 9 through a connection 90. Once the connection 90 is established, a voice connection (e.g., voice-over-IP) is established between the caller device 9 and the responder device 59, without divulging identifying information of either the caller device 9 or identifying information of the responder device 59 to the other party. Therefore, after the situation is corrected or after the responder reaches the caller, the voice-over-IP connection is terminated and neither party has knowledge of any addressing information of the other party (e.g., IP address or phone number). Privacy is maintained of both the caller and the responder as neither party has knowledge of the other party's phone number or any identifying information, therefore preserving privacy of both parties.

In one scenario of usage of the system for communicating between a responder 57 and a caller 12, when a stranded motorist calls 911 (e.g., the call center 81), the 911 operator will, in some embodiments, confirm the phone number of the caller 12 and send the caller 12 (e.g., the stranded motorist) information for installing the safetalk application 15 on the caller device 9 of the caller 12. In some embodiments, the safetalk application 15 is pre-installed on the caller device 9. After a responder 57 is identified/selected, the call center computer 80 connects the safetalk application 15 of the caller 12 with an application running on the responder device 59, allowing voice communications between the caller 12 and the responder 57 without disclosing the phone number of the caller 12 to the responder 57 and without disclosing any addressing information of the responder device 59 to the caller 12.

In some embodiments, location information is read from a location device such as a global positioning service 191/191A and the location information is exchanged with the call center computer 80 over a connection between the safetalk application 15 and the call center computer 80 or between the responder device 59 and the call center computer 80. This location information provides accurate location information of the caller 12 to the responder 57 and/or provides an updated location (or estimated time of arrival) of the responder to the caller 12 so that the caller can see how far the responder 57 is from the caller 12.

In some embodiments, the safetalk application 15 utilizes local location information (e.g., from global positioning subsystem 191) to determine the closest call center 81, making a call (phone call or voice over data call) to the closest call center 81).

In another scenario for usage of the system for communicating between a responder 57 and a caller 12, when a stranded motorist (caller 12) calls 911 (e.g., the call center 81) using the caller device 9, the dispatcher will, in some embodiments, confirm the phone number of the caller device 9 and connect the call center computer 80 to the safetalk application 15 running on the caller device 9. As most caller devices 9 have location reading systems such as global positioning subsystem 191, the safetalk application 15 will read location information from a global positioning subsystem 191 of the caller device 9 and transmit the location information to the call center computer 80. Having the location information at the call center computer 80, the dispatcher can verify an accurate location of the caller vehicle 10 and, in some embodiments, relay the accurate location of the caller vehicle 10 to software running on the responder device 59 for display on a map on the display of the responder device 59, optionally including directions on the best route for the responder 57 to take to reach the caller 10. In some embodiments, the call center computer connects the safetalk application 15 running on the caller device 12 with the software running on the responder device 59 only when the responder 57 is within a certain distance of the caller 12, allowing voice communications between the caller 12 and the responder 57 only when the responder 50 is close to the caller vehicle 10 and without disclosing the phone number of the caller 12 to the responder 57 and without disclosing any addressing information of the responder device 59 to the caller 12.

In some embodiments, the responder device 59 also has a global positioning service 191A (e.g., GPS) and the location of the responder 57 is periodically transmitted to the call center computer 80 (or to the safetalk application 15 running on the caller device 9). Having location information of the responder 57, in some embodiments, the call center computer 80 periodically transmits the location information and/or estimated time-of-arrival of the responder 57 to the caller device 12, where the safetalk application 15 receives the location information of the responder 50 and displays status information of the responder 57, for example, estimated time-of-arrival, distance from the caller vehicle 10, and/or a map showing the route and/or progress of the responder 57.

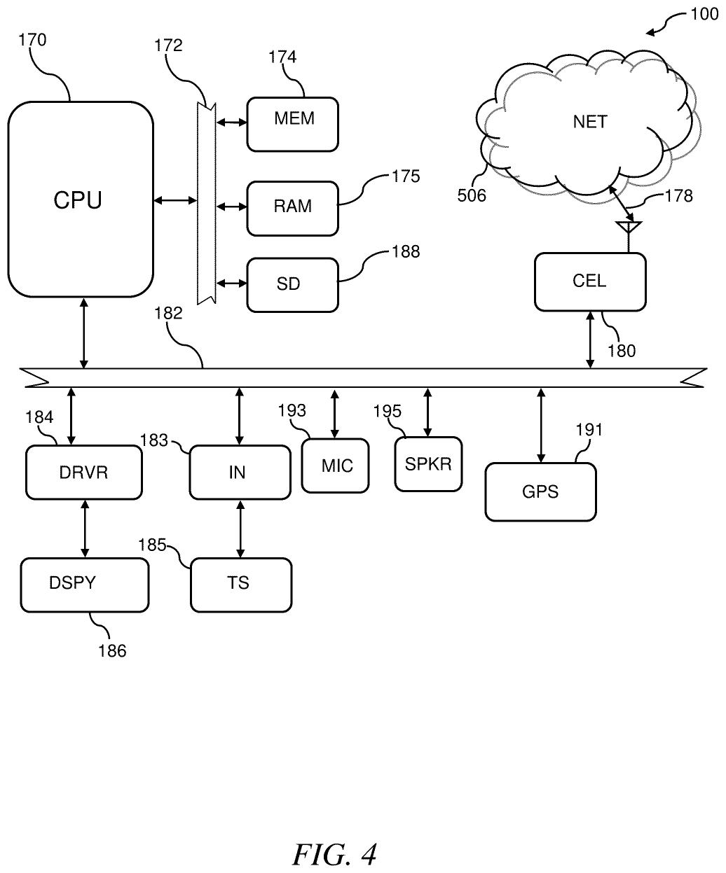

Referring to FIG. 4, a block diagram of an exemplary device 100 used as the caller device 9 and/or the responder device 59. The device 100 is a processor-based device for providing communications and processing, for example, a smartphone or tablet computer. The present invention is in no way limited to any particular device 100 and many other devices are anticipated.

The exemplary device 100 represents a typical device used for voice communications and for accessing user interfaces of the system for communicating with an occupant of a vehicle. This exemplary device 100 is shown in its simplest form. Different architectures are known that accomplish similar results in a similar fashion, and the present invention is not limited in any way to any particular system architecture or implementation. In this exemplary device 100, a processor 170 executes or runs programs in a random-access memory 175. The programs are generally stored within a persistent memory 174 and loaded into the random-access memory 75 when needed. In some devices 100, a removable storage 188 (e.g., compact flash, SD) offers removable persistent storage. The processor 170 is any processor, typically a processor designed for phones. The persistent memory 174, random-access memory 175, and removable storage slot are connected to the processor by, for example, a memory bus 172. The random-access memory 175 is any memory suitable for connection and operation with the processor 170, such as SRAM, DRAM, SDRAM, RDRAM, DDR, DDR-2, etc. The persistent memory 174 is any type, configuration, capacity of memory suitable for persistently storing data, for example, flash memory, read only memory, battery-backed memory, etc. In some agent computers 10, the persistent memory 174 is removable, in the form of a memory card of appropriate format such as SD (secure digital) cards, micro-SD cards, compact flash, etc.

Also connected to the processor 170 is a system bus 182 for connecting to peripheral subsystems such as a wireless network interface 180 (e.g., Cellular or Wi-Fi), a display driver 184 for driving a display device 186, an input port 183 for reading touch inputs from a touch screen interface 185, an audio input device 193, and audio transducer 195, though there is no restriction on types and configurations of inputs and outputs.

In general, some portion of the persistent memory 174 and/or the removable storage 188 is used to store executable code, and data, etc.

The peripherals are examples, and other devices are known in the industry such as a global positioning subsystem 191, the details of which are not shown for brevity and clarity reasons.

The wireless network interface 180 connects the device 100 to the data network 506 through any known or future protocol such as Ethernet, WI-FI, GSM, TDMA, LTE, etc., through a wired or wireless medium 178. There is no limitation on the type of connection used. The wireless network interface 180 provides data and messaging connections between the device 100 and, for example, the call center computer 80 through the data network 506.

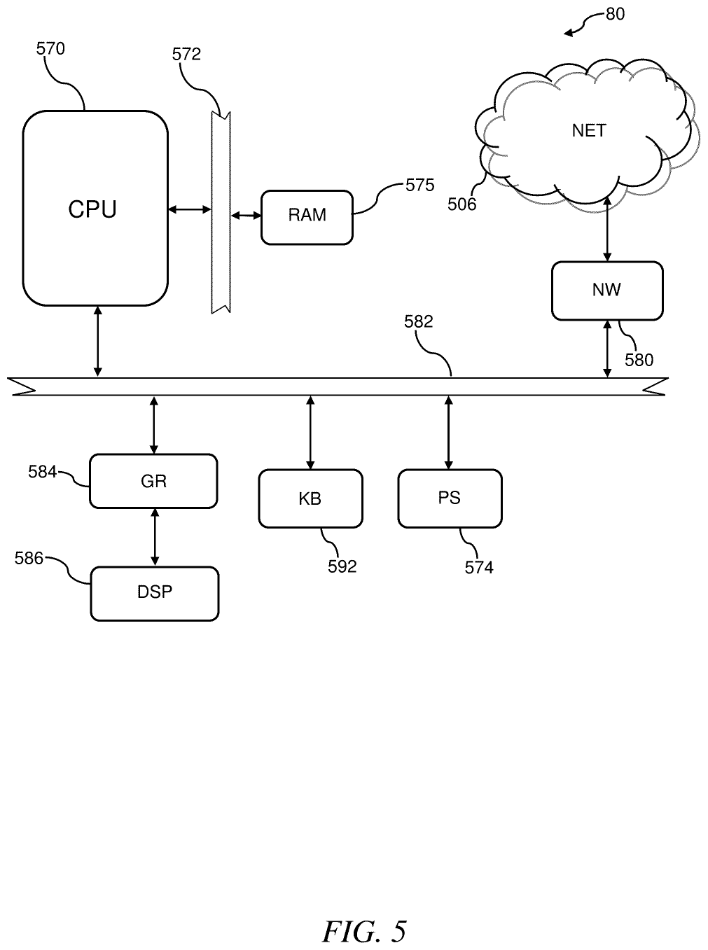

Referring to FIG. 5, an exemplary call center computer 80 as used by the system for communicating with an occupant of a vehicle is shown. The example call center computer 80 represents a typical computer system. This exemplary call center computer 80 (or server) is shown in its simplest form. Different architectures are known that accomplish similar results in a similar fashion and the present invention is not limited in any way to any particular computer system architecture or implementation. In this exemplary call center computer 80, a processor 570 executes or runs programs in a random-access memory 575. The programs are generally stored within a persistent memory 574 and loaded into the random-access memory 575 when needed. The processor 570 is any processor, typically a processor designed for computer systems with any number of core processing elements, etc. The random-access memory 575 is connected to the processor by, for example, a memory bus 572. The random-access memory 575 is any memory suitable for connection and operation with the processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, etc. The persistent memory 574 is typically interfaced to the processor 570 through a system bus 582, or any other interface as known in the industry.

Also shown connected to the system bus 582 is a network interface 580 (e.g., for connecting to a data network 506), a graphics adapter 584 and a keyboard interface 592 (e.g., Universal Serial Bus—USB). The graphics adapter 584 receives information from the processor 570 and controls what is depicted on a display 586. The keyboard interface 592 provides navigation, data entry, and selection features.

In general, some portion of the persistent memory 574 is used to store programs, executable code, data, contacts, and other data, etc.

The peripherals are examples and other devices are known in the industry such as pointing devices, touch-screen interfaces, speakers, microphones, USB interfaces, Bluetooth transceivers, Wi-Fi transceivers, image sensors, temperature sensors, etc., the details of which are not shown for brevity and clarity reasons.

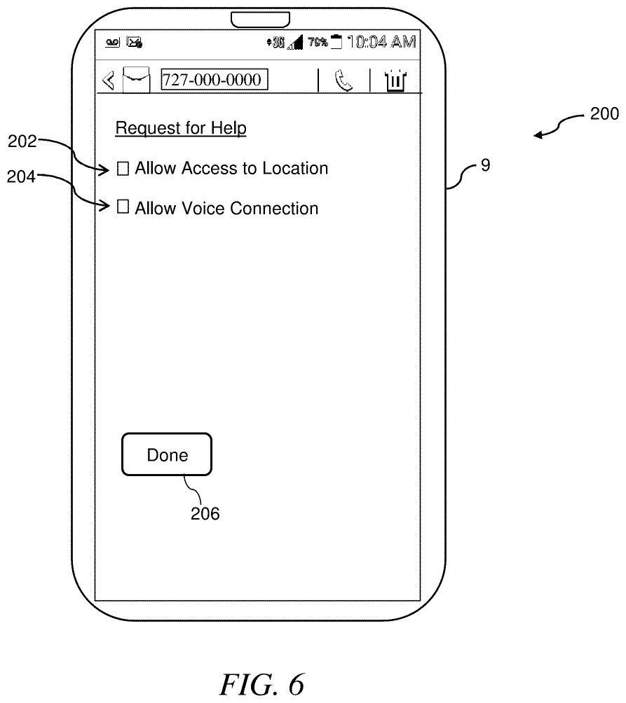

Referring to FIGS. 6-8, exemplary user interfaces of the system for communicating between a responder 57 and a caller 12 are shown. The user interfaces 200/220/240 are samples and in no way restrict the disclosed invention. The exemplary first user interface 200 (see FIG. 6) is presented by the safetalk application 15 after the caller 12 requests help from the call center 81. A dispatcher at the call center 81 requests information from the caller 12 (e.g., name, identifying information, type of trouble or emergency, location) and starts initiation of a responder 57 who will travel to the location of the caller 12. The dispatcher enters information into the call center computer 80 and the call center computer 80 communicates with the safetalk application 15 running on the caller device 9. In this example, the safetalk application 15 displays the exemplary first user interface 200 requests permission to allow access to location data 202 (e.g., from a global positioning subsystem 191 of the caller device 9) and to allow a voice connection with the responder device 59. After selecting done 206, if access to location data 202 is allowed, the safetalk application 15 reads the global positioning subsystem 191 of the caller device 9 and transmits the location data to the call center computer 80 for more accurate pinpointing of the caller 12. If a voice connection 204 is allowed, the safetalk application 15 informs the call center computer 80 and the call center computer 80 creates a voice connection (e.g., voice over IP) between the safetalk application 15 and the responder device 59, either directly or through the call center computer 80. Note that any user interface is anticipated and, in some embodiments, instead of requiring accepting permissions each usage, permission is provided by way of profile settings, etc.

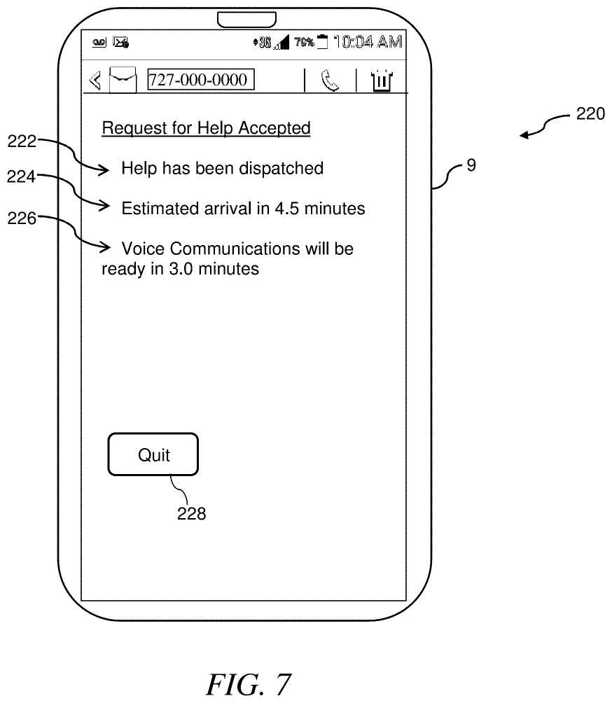

The exemplary second user interface 220 (see FIG. 7) is presented by the safetalk application 15 while the responder 50 is enroute to the caller vehicle 10. The exemplary second user interface 220 provides assurance and arrival information to the caller 12 regarding arrival time of the responder 57. In this example, an informational message 222 is displayed (e.g., “help has been dispatched”), though any message is anticipated. Also in this example, an estimated time of arrival 224 is displayed. The estimated time of arrival 224 is either based upon an initial estimate or the estimated time of arrival 224 is periodically updated with data transmitted from the call center computer 80, either as updated by the dispatcher or updated based upon location information received by the call center computer 80 from the global positioning subsystem 191A of the responder device 59. In some embodiments, voice communications are not enabled until the responder vehicle 50 is within a certain distance from the caller vehicle 10. In such embodiments, a message indicating the estimated time until voice communications will be available 226 is also displayed. For completeness, a “quit” option 228 is available.

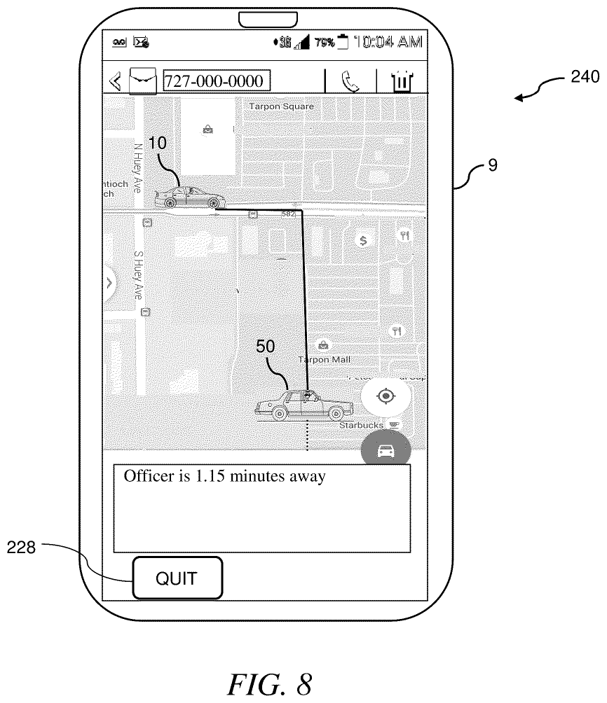

The third exemplary user interface 240 (see FIG. 8) is presented by the safetalk application 15 while the responder 50 is enroute to the caller vehicle 10. The third exemplary user interface 240 provides map-based information to the caller 12 regarding arrival of the responder 57. In this example, the current location of the responder vehicle 50 is graphically displayed with route information showing the route to the caller vehicle 10. The current location of the responder vehicle 50 is derived either as updated by the dispatcher or updated based upon location information received by the call center computer 80 from the global positioning subsystem 191A of the responder device 59. For example, software running on the responder device 59 periodically reads the global positioning subsystem 191A of the responder device 59 and transmits the location to the call center computer 80 and the call center computer either calculates an updated estimated time of arrival and transmits the updated estimated time of arrival to the safetalk application 15 running on the caller device 9 or transmits this location information to the safetalk application 15 running on the caller device 9 for displaying the location and/or process of the responder 57. Again, for completeness, a “quit” option 228 is available.

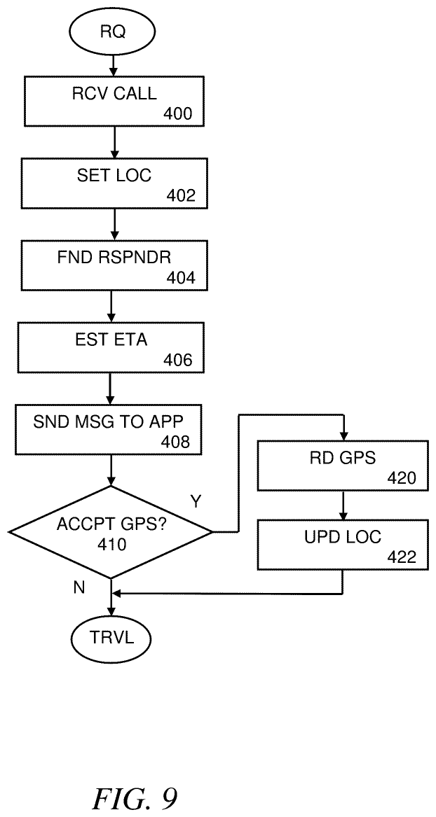

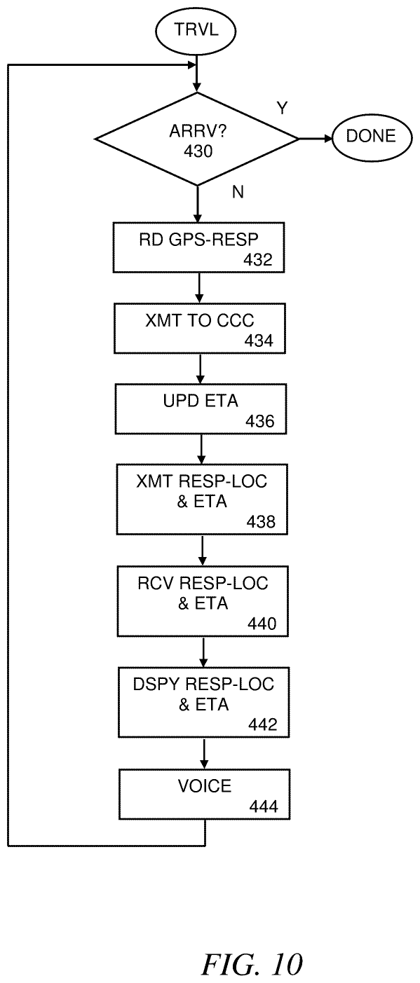

FIGS. 9 and 10 illustrate sample program flows of the system for communicating between a responder 57 and a caller 12. In FIG. 9, a request for help is received 400. The dispatcher sets a location 402 of the caller 12 based upon questions asked (e.g., “where is the accident”) and then finds a responder 404 (e.g., an officer, tow truck, and/or road warrior). Based upon the location of the responder 57, the dispatcher and/or the call center computer 80 calculates an ETA 406 (estimated time of arrival). Now information is sent to an application 408 that is running on the caller device 12 (e.g., to the safetalk application 15). The application either has preprogrammed parameters providing approval for access to location data and/or for establishing a voice connection to the caller device 12. If access to location data 410 is approved, the application (e.g., safetalk application 15) reads 420 the global positioning subsystem 191 of the caller device 12 and sends the location data to the call center computer 80 where the location is updated 422 to this more accurate location information.

In FIG. 10, the responder vehicle 50 is traveling to the caller vehicle 10. During this travel, when the responder vehicle 50 arrives 430 at the caller vehicle 10, the process completes. Until then, a loop repeats. Software of the system reads 432 the global positioning subsystem 191A of the responder device 59 to obtain a location of the responder vehicle 50 and transmits 434 this location to the call center computer 80 (or directly to the safetalk application 15 running on the caller device 59). The estimated time of arrival is updated 436, either by the call center computer 80 or the safetalk application 15 running on the caller device 59. The location of the responder vehicle 50 is transmitted 438 to the caller device 59. Upon reception 440 of the location of the responder vehicle 50 at the caller device 59, the safetalk application 15 displays 442 the location of the responder vehicle 50 and/or an updated estimated time of arrival. During the loop, voice communications 444 are provided between the caller device 12 and the responder device 59, for example, for the responder 57 to obtain more details of the issue/accident and for the caller 12 to receive assurance from the responder 57.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for communicating between a responder and a caller requesting help comprising:
a call center having means for receiving a call from a caller device of the caller, the call center having a call center computer;
means for dispatching the responder by the call center, the responder has a responder device, the responder device has a display, processor, memory, audio sensor and audio transducer;
means for installing and running a safetalk application on the caller device, the caller device having a caller device processor and a caller device display;
the call center computer is configured to connect to the safetalk application that is running on the caller device;
the call center computer is further configured to connect to an application running on the responder device; and
the call center computer establishes a voice-over-IP call between the safetalk application running on the caller device and the application running on the responder device, thereby, voice communications are initiated between the caller and the responder.

2. The system of claim 1, wherein the caller device has a location service and when the call center computer connects to the safetalk application running on the caller device, the safetalk application reads the location service and transmits an accurate location of the caller to the call center computer.

3. The system of claim 2, wherein after the safetalk application reads the location service and transmits the accurate location of the caller to the call center computer, the call center computer transmits the accurate location to the application running on the responder device.

4. The system of claim 1, wherein the responder device has a responder device location service and after the call center computer connects to the application running on the responder device, the application running on the responder device periodically reads the responder device location service and transmits a responder location to the call center computer.

5. The system of claim 4, wherein the call center computer periodically transmits the responder location to the safetalk application running on the caller device and upon receiving the responder location at the caller device, the safetalk application displays the responder location on the caller device display.

6. The system of claim 5, wherein the safetalk application displays the responder location on a map displayed on the caller device display.

7. The system of claim 4, wherein the call center computer periodically calculates an estimated time-of-arrival of the responder and transmits the estimated time-of-arrival to the safetalk application running on the caller device and upon receiving the estimated time-of-arrival at the caller device, the safetalk application displays the estimated time-of-arrival on the caller device display.

8. A method for communicating between a responder and a caller requesting help, the method comprising:
receiving a call at a call center, the call coming from a caller device of the caller, the call center having a call center computer;
dispatching the responder by the call center, the responder having a responder device, the responder device having a display, processor, memory, audio input and audio output;
running a safetalk application on the caller device, the caller device having a caller device processor and a caller device display;
the call center computer connecting to the safetalk application that is running on the caller device;
the call center computer connecting to an application running on the responder device; and
the call center computer initiating a voice-over-data connection between the safetalk application running on the caller device and the application running on the responder device, thereby providing voice communications between the caller and the responder.

9. The method of claim 8, wherein the caller device has a location service and after the call center computer connecting to the safetalk application running on the caller device, the safetalk application reading the location service and the safetalk application transmitting an accurate location of the caller to the call center computer.

10. The method of claim 9, wherein after receiving the accurate location of the caller to the call center computer, the call center computer transmitting the accurate location to the application running on the responder device and the responder device displaying the accurate location on the display of the responder device.

11. The method of claim 8, wherein the responder device has a responder device location service and periodically reading a responder device location from the responder device location service by the application running on the responder device and the application running on the responder device transmitting the responder device location to the call center computer.

12. The method of claim 11, wherein periodically transmitting the responder device location from the call center computer to the safetalk application running on the caller device and upon receiving the responder device location at the caller device, the safetalk application displaying the responder device location on the caller device display.

13. The method of claim 12, wherein the safetalk application displaying the responder device location is on a map on the caller device display.

14. The method of claim 11, further comprising periodically calculating an estimated time-of-arrival of the responder by the call center computer and the call center computer transmitting the estimated time-of-arrival to the safetalk application running on the caller device and upon receiving the estimated time-of-arrival at the caller device, displaying the estimated time-of-arrival by the safetalk application on the caller device display.

15. A system for communicating between a responder and a caller requesting help comprising:
a call center having means for receiving a call from a caller device of the caller, the call center having a call center computer;
the responder has a responder device, the responder device has a display, processor, memory, audio input and audio output;
a safetalk application installed on the caller device, the caller device having a caller device processor and a caller device display;
the call center computer connects to the safetalk application that is running on the caller device processor of the caller device;
the call center computer connects to an application running on the processor of the responder device; and
the call center computer establishes a voice-over-data call between the safetalk application running on the caller device processor and the application running on the processor of the responder device, thereby, voice communications are initiated between the caller and the responder.

16. The system of claim 15, wherein the responder device has a responder device location service and after the call center computer connects to the application running on the responder device, the application running on the responder device periodically reads a responder device location from the responder device location service and the application running on the responder device periodically transmits the responder device location to the call center computer, upon receiving the responder device location, the call center transmits the responder device location to the safetalk application running on the caller device and upon receiving the responder device location at the caller device, the safetalk application displays the responder device location on the caller device display.

17. The system of claim 16, wherein the safetalk application displays the responder device location on a map displayed on the display of the caller device.

18. The system of claim 15, wherein the safetalk application is pre-installed on the caller device.

19. The system of claim 15, wherein the call center computer transmits a link to the caller device and upon activating the link, the safetalk application is installed on the caller device.
